(19) United States
(12) Patent Application Publication
(10) Pub. No.: US 2026/0248283 A1
(43) Pub. Date: Aug. 27, 2026

(54) ANCHOR GUARD

(71) Applicant: Frazier Industrial Company, Long Valley, NJ (US)

(72) Inventors: Kevin Lonsdorf, Bound Brook, NJ (US); Mark Boehnke, Waterloo, NY (US); Doug Cowley, Bethlehem, PA (US)

(21) Appl. No.: 19/063,895

(22) Filed: Feb. 26, 2025

(51) Int. Cl. A47B 91/08

(52) U.S. Cl. CPC A47B 91/08

(57) ABSTRACT

An anchor guard for protecting a column, base support plate and anchoring hardware in a storage rack from vehicular impact, is provided. The anchor guard of the present invention consists of a substantially C or U shape design and engages with a base plate and vertical column secured to the a fix surface by anchoring hardware, of which the anchor guard is further anchored in place. The anchor guard may also have a partition extending across the interior of the anchor guard for abutting the vertical column of a storage rack.

### BACKGROUND OF THE INVENTION

The present invention is directed to protecting a warehouse storage rack from undue impact of storage vehicles operating thereat.

Pallets of goods are stored on multi-level warehouse storage racks with vertically aligned gaps therebetween to define aisles for a moving storage vehicle, i.e., a pallet truck, to store pallets on the various levels and retrieve the pallets therefrom.

The storage racks often employ four, five or more vertically aligned levels of storage rack bays, each of which can be many pallets deep. Some systems, for example, can be 10, 20, 30 or more pallets deep. Such racks are typically formed with vertical columns, which support horizontal rails running lengthwise from the front of a storage bay row to the rear of each bay.

More particularly, the vertical columns supporting the storage racks are anchored into the ground using various types of anchoring hardware inserted through a base supporting plate. The lower parts of such columns, the base plates, and especially the anchoring hardware are exposed to unwanted impact from a storage vehicle such as a forklift truck, damaging the column, the plate, and the anchoring hardware, and undermining the integrity of the entire rack system. In particular, a single hit from a vehicle can sheer off the anchoring hardware thus causing the base plate to become unsecured from the ground.

Accordingly, there is a need to protect such vertical columns, base plates, and the anchoring hardware (i.e. anchors) from unwanted, undue impact of storage vehicles moving in close proximity thereto.

### SUMMARY OF THE INVENTION

Accordingly, it is an object of the present invention to protect a storage rack system, e.g., for storing pallets, from unwanted impact and damage due to movement of a storage vehicle in close proximity thereto.

It is a more specific object of the present invention to shield a lower portion of a vertical column supporting the storage racks base plates, and in particular anchoring hardware, such as anchors or bolts, secured to the ground from inadvertent impact of an operating vehicle, such as a forklift truck, storing goods on and removing stored goods from the rack; other anchoring hardware are contemplated.

It is another object of the present invention to provide a shield that can be easily incorporated around and secured to the vertical column and base of the storage rack to protect the anchoring hardware from vehicular impact.

These and other objects are attained by the present invention which is directed to an anchor guard for protecting a vertical column, base support plate, and anchoring hardware for the vertical column in a storage rack, and having a portion at least partially surrounding the column and support plate, and mechanism for securing the anchor guard to the column and support plate. A partition extends across the anchor guard between opposite edges thereof, with at least one slot extending downwardly from a top edge of the partition and curved at a bottom thereof. The anchor guard itself is preferably in the shape of a C or U, e.g., a C-or U-shaped bracket.

The anchor guard can be easily affixed to the vertical column and support plate after the column and support plate have been anchored in the ground using anchoring hardware, and the rack assembled, and effectively absorb unwanted impact from a vehicle such as a forklift truck, preserving integrity and stability of the overall rack. In particular, the shape and configuration of the anchor guard, notably the slot and partition, allows fixing to a variety of columns and base plates at various vertical levels thereof.

### BRIEF DESCRIPTION OF THE DRAWINGS

The present invention will be described in greater detail with reference to the accompanying drawings, in which

FIG. 1 is a top, right perspective view of the anchor guard of the present invention,

FIG. 2 is a top plan view of the anchor guard,

FIG. 3 is a bottom plan view of the anchor guard,

FIG. 4 is a front elevational view of the anchor guard,

FIG. 5 is a rear elevational view of the anchor guard,

FIG. 6 is a right side elevational view of the anchor guard, the left side elevational view being a substantial mirror image thereof,

FIG. 7 is a top left perspective view showing the anchor guard secured around a column, base plate, and anchoring hardware of a storage rack,

FIG. 8 is a top left perspective view similar to FIG. 7 and schematically showing the anchor guard being secured to the column of the storage rack, and around the base plate and anchoring hardware, and

FIG. 9 is a perspective view of a storage system showing anchor guards respectively secured to columns and around base plates and anchoring hardware and defining an aisle through the system.

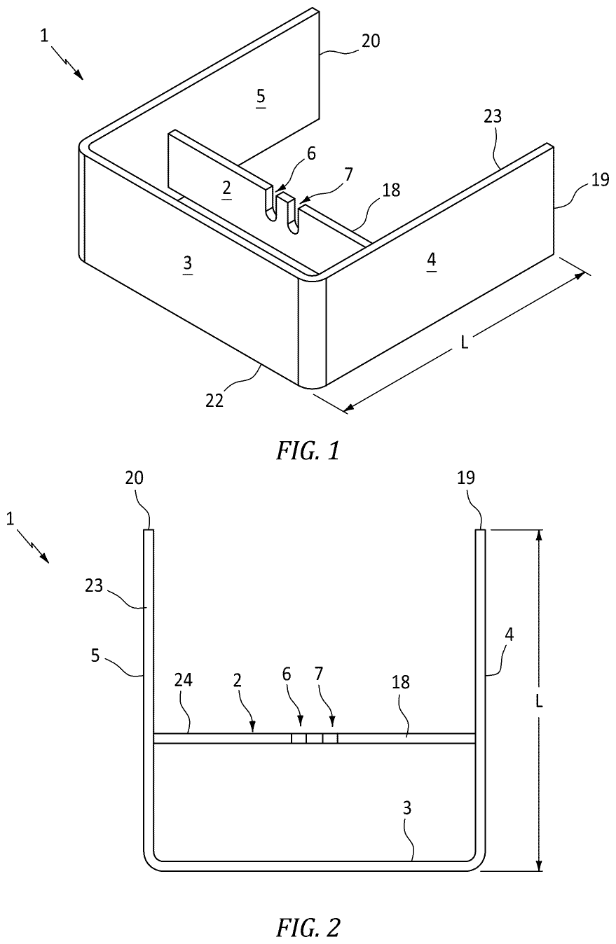

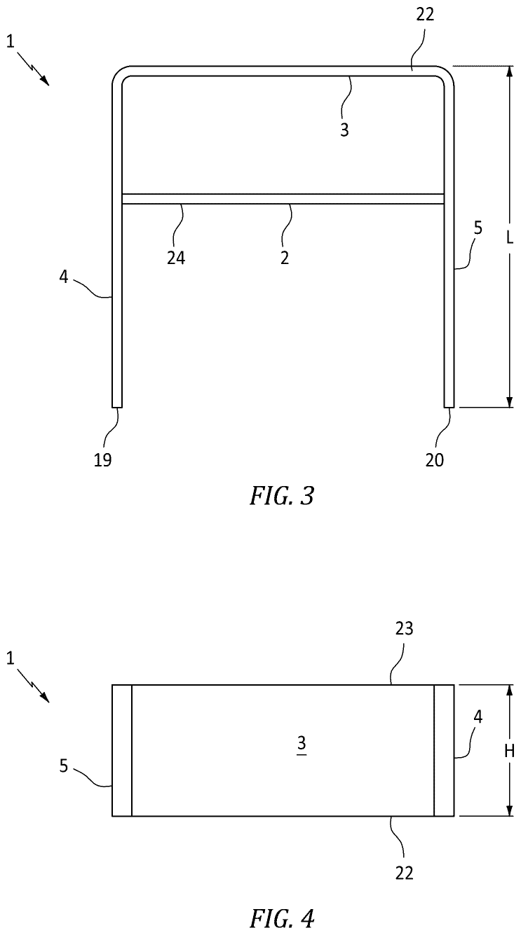

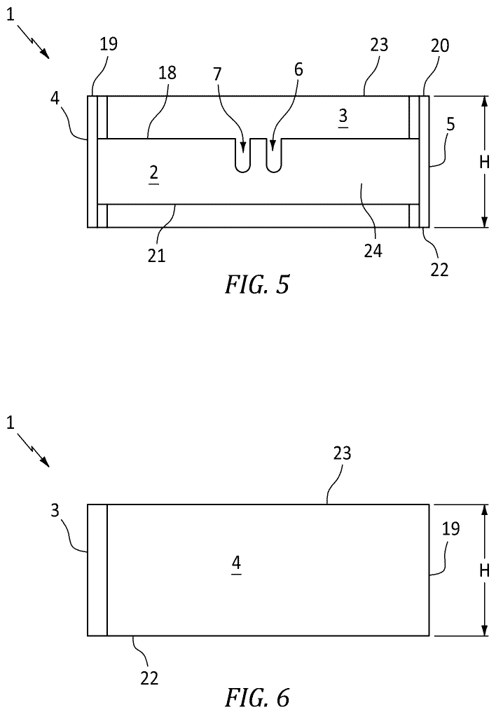

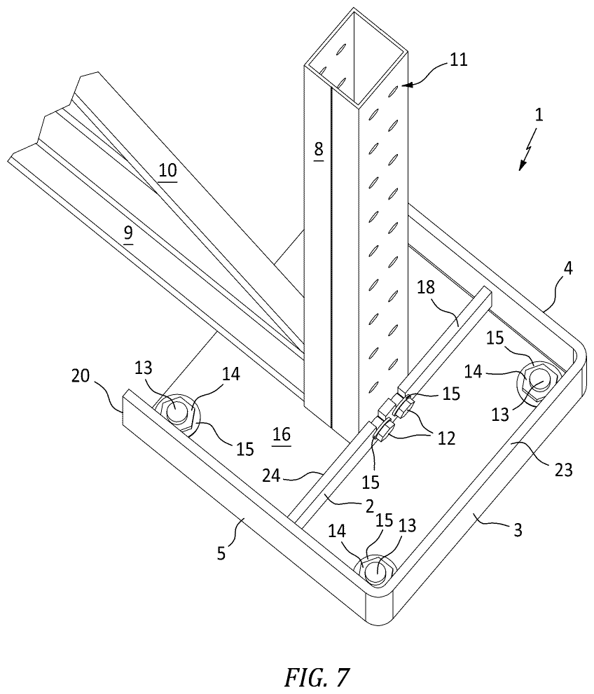

### DETAILED DESCRIPTION OF THE PREFERRED EMBODIMENTS

Referring to the drawings, the anchor guard 1 of the present invention is preferably in the shape of a C or U, e.g., a C-or U-shaped bracket, having a front side 3 and two lateral sides 4, 5. A partition 2 extends between the lateral sides 4, 5 and parallel to the front side 3, and has, preferably, two slots 6, 7 extending downwardly from a top edge 18 thereof, with the bottom of the respective slots 6, 7 curved so that the slots 6, 7 are substantially U-shaped. It is contemplated that more or less than two slots extending downwardly from a top edge may be employed, but two slots are in the preferred embodiment as the standard steel column has two columns of anchoring holes.

The partition 2 is situated closer to the front side 3 of the anchor guard 1 than to opposite edges or ends 19, 20 of the respective lateral sides 4, 5 thereof, e.g., between about ⅓ to about 40% of the length L of the respective lateral sides 4, 5. The bottom edge 21 of the partition 2 is situated at a level above the bottom 22 of the anchor guard 1 defined by the front 3 and lateral 4, 5 sides, to allow the anchor guard 1 to be positioned around a base support plate 16 and anchoring hardware 13, 14 and 15 for a vertical column 8 in a storage rack, as described further infra, to permit the partition to pass clearly over the base plate. It is contemplated and preferred that the distance from the bottom edge 21 of the partition 2 to the bottom 22 of the anchor guard 1 would reasonably accommodate both a base support plate affixed to a fixed surface as well as a base support plate 16 having shims affixed to a fixed surface such that the bottom 22 of a single anchor guard 1 rests on the fixed surface (i.e. the ground) in both instances. The top edge 18 of the partition 2 is also situated below a top edge 23 of the anchor guard 1 defined by the front 3 and lateral 4, 5 sides. While the aforementioned ranges of distances of the top and bottom edge 18, 21 with respect to the top and bottom edge 23, 22 of the anchor guard 1 are preferred, other measurements are contemplated to adapt to anchor guards 1 of varying sizes, vertical column 8 having holes 11 located at varying heights, storage rack anchoring systems of varying sizes, and/or partitions 2 of varying sizes.

The anchor guard 1 of the present invention can be securely fastened to a column 8 of a storage rack and surround a base support plate 16 for the vertical column 8 as shown in FIG. 7, to protect the storage rack anchoring system having, at least, a column 8, plate 16 and anchoring hardware 13, 14 and 15 securing the vertical column 8 to a fixed surface and overall rack from impact of a vehicle such as a pallet or fork lift truck. The anchoring hardware is described herein as a bolt 13, nut 14 and washer 15, but other anchoring hardware are contemplated.

More particularly, as shown, e.g. in FIGS. 7-9, the storage rack is formed by a series of vertical columns 8, horizontal cross-beams 9, and diagonal bracing struts 10 defining several levels of bays (not shown) for storing heavy items, e.g., situated on portable platforms or pallets. These items, e.g., together with the supporting pallets are loaded on and unloaded from the various storage bays by a storage vehicle, e.g., a forklift truck. While it is contemplated that the anchor guard 1 of the present invention may be employed in various storage rack systems that may include a vertical column, base plate and anchoring hardware, variations of the storage rack anchoring systems using the same or different methods of securing the vertical column to a fixed surface and implementing the anchor guard of the present invention to protect said storage racks are contemplated.

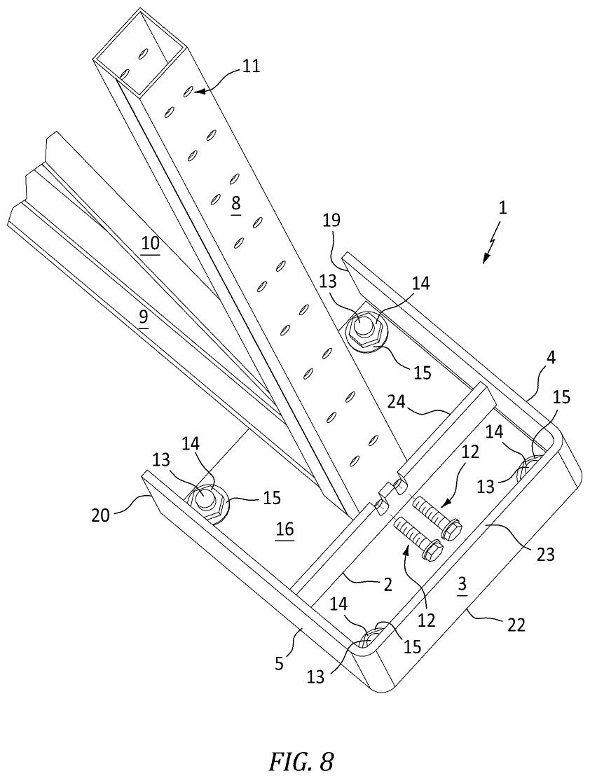

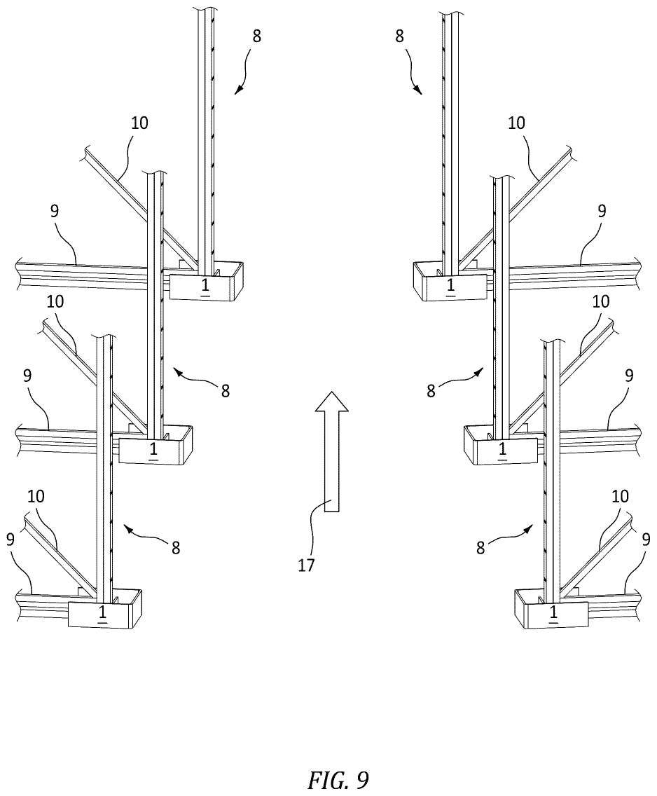

As schematically shown in FIG. 8, after the storage rack is anchored in place, i.e., after the base plate 16 supporting the respective vertical column 8 is anchored in the ground through the anchoring hardware, which can include bolts 13, nuts 14, and washers 15 (other anchoring hardware is contemplated), the anchor guard 1 is positioned around the base support plate 16 with a rear side 24 of the partition 2 abutting against the vertical column 8, and slots 6, 7 aligned with respective lines of holes 11 along the vertical column 8 as shown. Next, bolts 12 together with nuts 14 and, preferably, washers 15 are inserted through the respective slots 6, 7 and into holes 11 along the respectively-aligned columns of holes 11.

The respective bolts 12 are then tightened in place by securing nuts (not shown) on the ends of the bolts 12 protruding through the respective holes 11 in the vertical column 8, as shown in FIG. 7. In particular, the U-shaped slots 6, 7 can register with different holes 11 along the line or column of holes 11 through the vertical column 8, improving versatility, since the anchor guard 1 need not be precisely aligned with specific holes 11 in the column 8. The U-shaped slots 6,7, allows for accommodating supporting base plates 16 of different thickness, and/or the inclusion of a shim or shims if the floor is not level, such that the U-shaped slots may align with holes 11 of vertical column 8 and connected by bolt 12.

The anchor guard 1 is made from welded metal or may be extruded from metal, and preferably has a length of approximately 13″, a width of approximately 13″ and a height of approximately 5′, with partition 2 disposed approximately 5.25″ from the front side 3, although other sizes and spacing of the partition 3 in relation to the frame of the anchor guard 1 are contemplated. The anchoring hardware 13, 14 and 15, columns 8, support plates 16, horizontal support beams 9, bracing struts 10, and overall racks are protected from damage by a moving vehicle such as a forklift truck negotiating the aisles 17 defined between rows of columns 8, e.g., in a warehouse. More particularly, the anchor guard 1 can effectively absorb unwanted impact from such a vehicle, preserving integrity and stability of the overall rack.

The preceding description of the present invention is merely exemplary and not intended to limit the scope thereof in any way.

What is claimed is:

1. An anchor guard for protecting a storage rack anchoring system having anchoring hardware used to secure a column and base support plate to a fixed surface, comprising:
a portion configured to at least partially surround the column and base support plate, and
mechanism for securing the anchor guard to the column and support plate.

2. The anchor guard of claim 1, additionally comprising:
a partition extending across the interior of the anchor guard between opposite edges thereof.

3. The anchor guard of claim 1, comprising:
at least one slot extending downwardly from a top edge of the partition.

4. The anchor guard of claim 3, wherein said slot has a curved base at a bottom thereof.

5. The anchor guard of claim 4, comprising two said slots extending downwardly from the top edge of the partition and each having a curved base at the bottom thereof.

6. The anchor guard of claim 1, substantially in the shape of a C or U.

7. The anchor guard of claim 6, additionally comprising:
a partition extending across the interior of the anchor guard between opposite sides of the C or U bracket-shaped anchor guard and parallel to a front side of the anchor guard.

8. The anchor guard of claim 7, comprising:
at least one slot extending downwardly from a top edge of the partition.

9. The anchor guard of claim 8, wherein said slot has a curved base at a bottom thereof.

10. The anchor guard of claim 9, comprising two said slots extending downwardly from the top edge of the partition and each having a curved base at the bottom thereof.

11. The anchor guard of claim 7, wherein said partition is disposed closer to the front side of the anchor guard than to tips of the C or U bracket-shaped anchor guard.

12. The anchor guard of claim 7, wherein said partition has a height less than height of the anchor guard, with a bottom edge of said partition positioned above a bottom edge of the anchor guard and a top edge positioned below a top edge of the anchor guard.
